(19) United States
(12) Patent Application Publication
(10) Pub. No.: US 2015/0294344 A1
(43) Pub. Date: Oct. 15, 2015

(54) Methods and Systems for Providing Interaction and Purchasing Within Online Chat

(71) Applicant: Opia Holdings, Inc., Baltimore, MD (US)

(72) Inventors: Thomas Popomaronis, Phoenix, MD (US); William Popomaronis, Phoenix, MD (US); Richard Evins, Punta Gorda, FL (US)

(73) Assignee: Opia Holdings, Inc., Baltimore, MD (US)

(21) Appl. No.: 14/547,333

(22) Filed: Nov. 19, 2014

Related U.S. Application Data
(60) Provisional application No. 61/978,837, filed on Apr. 12, 2014.

(51) Int. Cl. G06Q 30/02; G06Q 50/00

(52) U.S. Cl. CPC G06Q 30/0235; G06Q 50/01; G06Q 30/0241

(57) ABSTRACT

The invention is directed toward a computer implemented method of providing a group discount to a plurality of consumers comprising establishing a threshold number of consumers required for the implementation of a discount, generating an advertisement to present a discount offer to potential consumers, displaying the advertisement for potential consumers to review, receiving acceptances of the discount offer, determining if the threshold number of consumers has been attained, informing potential consumers whether or not the threshold number of consumers has been attained, activating a discount for one or more consumers who have accepted the discount offer when the threshold number of consumers has been attained or exceeded, accepting the activated discount for a predetermined period of redemption time when the discount is presented for redemption by a consumer during a transaction session, and deactivating the activated discount after the expiration of the predetermined period of redemption time.

### PRIORITY

This application claims the benefit of U.S. Provisional Application No. 61/978,837, filed 12 Apr. 2014.

### FIELD OF THE INVENTION

The present invention relates to a system and method for conducting electronic commerce and more particularly to providing a live system and method for online interaction between a merchant and a group of consumers whereby a merchant offers a group discount to a group of consumers in real time.

### BACKGROUND OF THE INVENTION

Selling online can be a difficult process. Standard e-commerce websites report an average conversion rate of 2.2%. Consumers shop online and often browse multiple sites for deals before making a purchase. In addition, online shopping limits the social aspect of group shopping. Purchases online are often completed in isolation from other consumers, without the opportunity to solicit immediate feedback from other consumers at the time of purchase. In addition, online shopping is limited by the fact that consumers are not able to engage directly with sales representatives during the purchasing process. Consumers must often purchase items for sale while still having questions about an item or being uncertain whether they have selected the correct item for purchase to meet their needs.

Furthermore, group discount websites are well known in the prior art. In the standard embodiment of the group discount method, a merchant provides a discount through a third party website. The group discount only becomes effective if a predetermined number of consumers purchase the group discount. As an example, a merchant may provide a coupon worth twenty dollars of merchandise for sale for ten dollars which only become effective if twenty consumers purchase the group discount. This group discount is normally offered for a specified period of time through a third party website. The group discount is emailed to a group of consumers registered with the third party website. The individual consumers decide whether or not to purchase the group discount individually in their own time. One consumer purchases the group discount independently from other consumers and may not know until notified later that the predetermined number of consumers purchased the group discount. This method is limited in that consumers are separated when each makes a purchase of a group discount.

What is needed is an easy way for e-commerce retailers to interact with consumers, edit the purchase price available for those consumers during the interaction, allow consumers to interact with the retailer and other consumers during the purchasing process, and allow consumers to purchase a good or service directly during the interaction. In addition, what is needed is a method and system for providing a group discount to a group of consumers whereby the consumers may interact with each other, with the merchant, invite additional consumers to interact, and purchase the group discount simultaneously.

### SUMMARY OF INVENTION

The invention disclosed and claimed herein is sufficiently patentable and is directed toward a system and method with meaningful limitations beyond linking an abstract idea to a computer environment. As an example, and without limitation, the system and method involve the computerized tracking and measurement of group purchasing habits and a computerized method of automating the presentation of advertisements and activation of discounts for potential consumers. In addition, the system and method claimed herein is directed toward improvements in the administration of computerized retail systems and methods.

The invention is directed toward a computer implemented method of providing a group discount to a plurality of consumers comprising, on a server computer connected to one or more client computers through a network, the server computer comprising a microprocessor and a nonvolatile memory unit, the nonvolatile memory unit storing instructions which when executed by the microprocessor cause the server computer to perform operations comprising establishing a threshold number of consumers required for the implementation of a discount, generating an advertisement to present a discount offer to potential consumers, displaying the advertisement for a predetermined period of display time for potential consumers to review, receiving acceptances of the discount offer during the predetermined period of display time, determining if the threshold number of consumers has been attained during the predetermined period of display time, informing potential consumers whether or not the threshold number of consumers has been attained, activating a discount for one or more consumers who have accepted the discount offer when the threshold number of consumers has been attained or exceeded, accepting the activated discount for a predetermined period of redemption time when the discount is presented for redemption by a consumer during a transaction session, and deactivating the activated discount after the expiration of the predetermined period of redemption time.

The method may further comprise displaying to potential consumers the user information of all potential consumers who have accepted the discount offer. The method may further comprise providing a chat room session on the server computer wherein potential consumers may post text messages.

The method may further comprise providing a social network interface. The social network interface permits potential consumers who have accepted the discount offer to notify social connections about the discount offer and invite social connections to view the advertisement presenting the discount offer. The method may further displaying to potential consumers the user information of all potential consumers who have accepted the discount offer. The method may further comprise providing a chat room session on the server computer wherein potential consumers may post text messages.

In another embodiment the advertisement may present a count indicator. The count indicator may indicate the number of potential consumers who have accepted the discount offer or may indicate the number of potential consumers required to attain the threshold number of consumers.

In another embodiment the advertisement presents a display time indicator. The display time indicator presents the time remaining in the predetermined period of display time.

In another embodiment of the invention the method further comprises displaying a redemption time indicator. The redemption time indicator presents the time remaining in the predetermined period of redemption time. Furthermore the activated discount may be effectuated by presenting a discount code to the plurality of consumers who have accepted the discount offer. Furthermore, the activated discount may be activated for no more than fifteen minutes after the threshold number of consumers has been attained. The method may further comprise requiring the potential consumers to log into a user profile prior to accepting the discount offer.

The method may further comprise presenting services or merchandise for purchase by the potential consumers, receiving notification of selection of services or merchandise for purchase by the one or more consumers, and storing the selected services or merchandise in a consumer specific shopping cart.

The method may further comprise receiving a request to initiate a transaction session from one or more of consumers who have accepted the discount offer, collecting transaction information during the transaction session from one or more consumers at respective clients in order to facilitate the purchase of selected services or merchandise, and processing transaction information collected during the respective transaction sessions.

The invention is also directed toward a system for providing a group discount to a plurality of consumers comprising a server computer, one or more client computers communicatively connected to the server computer, a database communicatively connected to the server computer, and a group discount module stored on the server computer. The group discount module comprising executable computer code, which when executed by the server computer, performs a method comprising establishing a threshold number of consumers required for the implementation of a discount, generating an advertisement to present a discount offer to potential consumers, displaying the advertisement for a predetermined period of display time for potential consumers to review, receiving acceptances of the discount offer during the predetermined period of display time, determining if the threshold number of consumers has been attained during the predetermined period of display time, informing potential consumers whether or not the threshold number of consumers has been attained, activating a discount for one or more consumers who have accepted the discount offer when the threshold number of consumers has been attained or exceeded, accepting the activated discount for a predetermined period of redemption time when the discount is presented for redemption by a consumer during a transaction session, and deactivating the activated discount after the expiration of the predetermined period of redemption time. The system may further perform the method of receiving a request to initiate a transaction session from one or more of consumers who have accepted the discount offer, collecting transaction information during the transaction session from one or more consumers at respective clients in order to facilitate the purchase of selected services or merchandise, and processing transaction information collected during the respective transaction sessions. The system may further perform the method of displaying to potential consumers the user information of all potential consumers who have accepted the discount offer. The system may further perform the method of providing a chat room session on the server computer wherein potential consumers may post text messages.

The system may further perform the method of providing a social network interface. The social network interface permits potential consumers who have accepted the discount offer to notify social connections about the discount offer and invite social connections to view the advertisement presenting the discount offer. The system may further perform the method of displaying to potential consumers the user information of all potential consumers who have accepted the discount offer. The system may further perform the method of displaying a redemption time indicator. The redemption time indicator presents the time remaining in the predetermined period of redemption time. In this system, the activated discount may be effectuated by presenting a discount code to the plurality of consumers who have accepted the discount offer.

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of a computer network utilizing the invention.

FIG. 2 is a view of a screenshot of one embodiment of the invention.

FIG. 3 is a view of a screenshot of one embodiment of the invention.

FIG. 4 is a view of a screenshot of one embodiment of the invention.

FIG. 5 is a view of a screenshot of one embodiment of the invention.

FIG. 6 is a view of a screenshot of one embodiment of the invention.

FIG. 7 is a view of a screenshot of one embodiment of the invention.

FIG. 8 is a view of a screenshot of one embodiment of the invention.

FIG. 9 is a view of a screenshot of one embodiment of the invention.

FIG. 10 is a view of a screenshot of one embodiment of the invention.

FIG. 11 is a view of a screenshot of one embodiment of the invention.

FIG. 12 is a view of a screenshot of one embodiment of the invention.

FIG. 13 is a view of a screenshot of one embodiment of the invention.

FIG. 14 is a close up view of a display advertisement.

FIG. 15 is a view of a screenshot of one embodiment of the invention.

FIG. 16 is a schematic of the method performed by the system.

FIG. 17 is a schematic of the method performed by the system.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

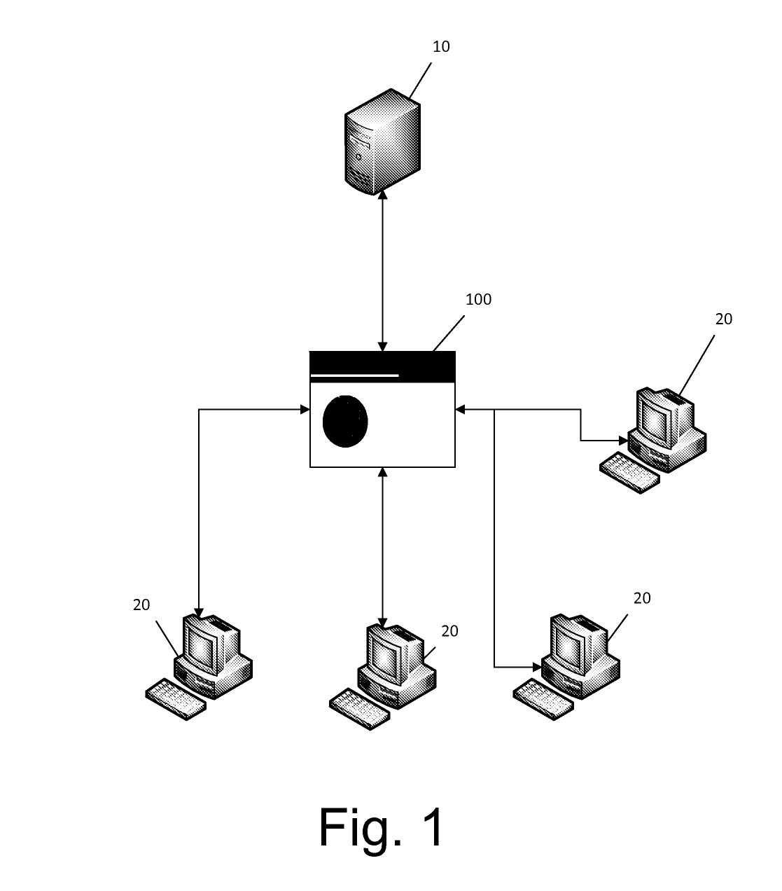

Referring to FIG. 1, the system utilizing the invention is displayed. The system comprises a network server 10 which presents a specialized website 100 over a network connection to one or more client computers 20. Each respective user of a client computer 20 views the specialized website 100 in real time such that all client computers 20 see an identical presentation on the specialized website 100 at any moment in time.

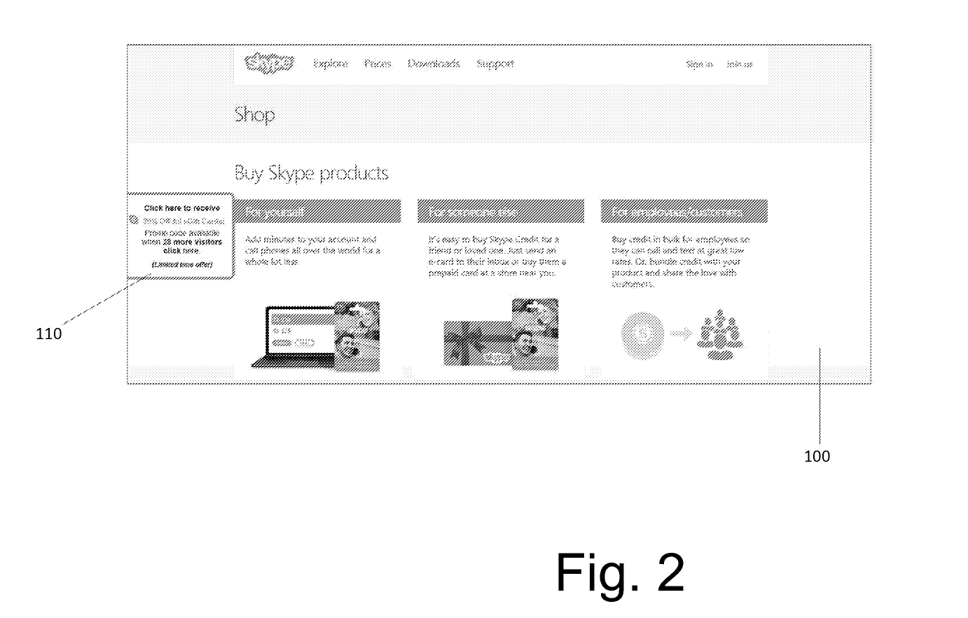

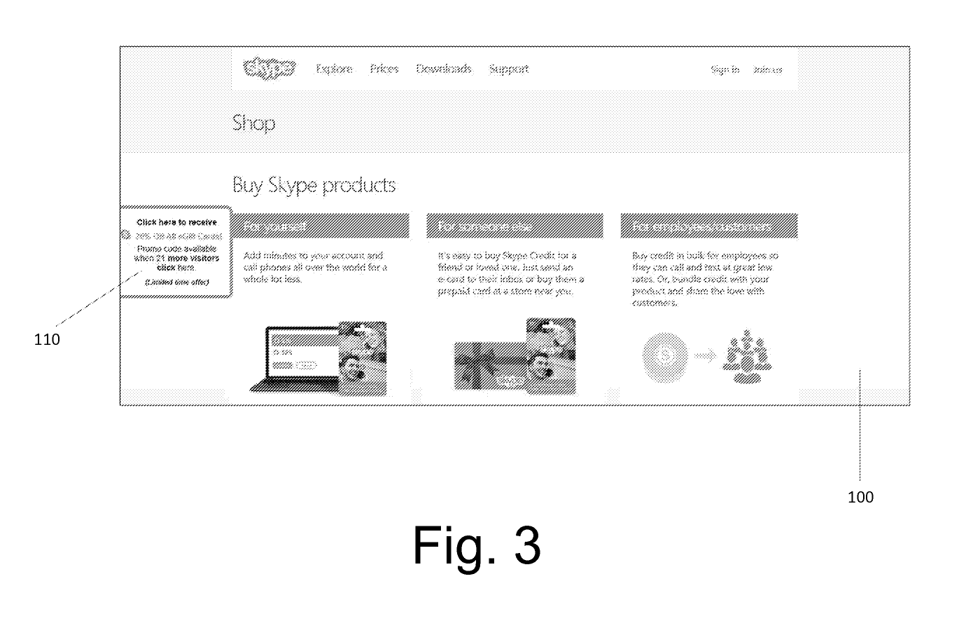

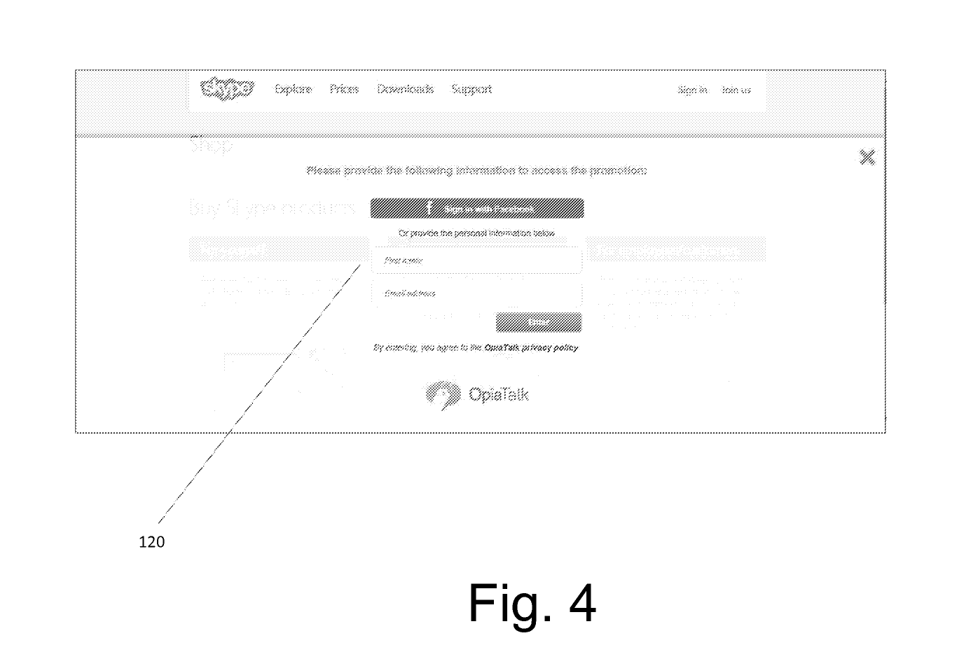

Referring to FIG. 2-13, the utilization of the specialized website 100 is displayed. As shown in FIG. 2, when a consumer first navigates to the specialized website 100, the consumer is shown an advertisement 110. The advertisement displays a discount offer and the number of consumers required to accept the discount offer in order for the discount to become activated. As shown in FIG. 2, the advertisement 110 states that an additional twenty eight consumers are required before the discount code becomes activated for all consumers. As time proceeds and consumers accept the discount offer presented in the advertisement 110, the number of consumers required to accept the discount offer decreases. For example, as displayed in FIG. 3, the advertisement 110 on the specialized website 100 requires an additional twenty one consumers to accept the offer before the discount is activated. When a potential consumer decides to accept the discount offer, the potential consumer clicks on the advertisement 110. The system then redirects the potential customer to a login system. As displayed in FIG. 4, the user may login utilizing a social media login 120, such as facebook. In some embodiments of the invention, the potential may utilize the system without logging in or utilizing social media login 120.

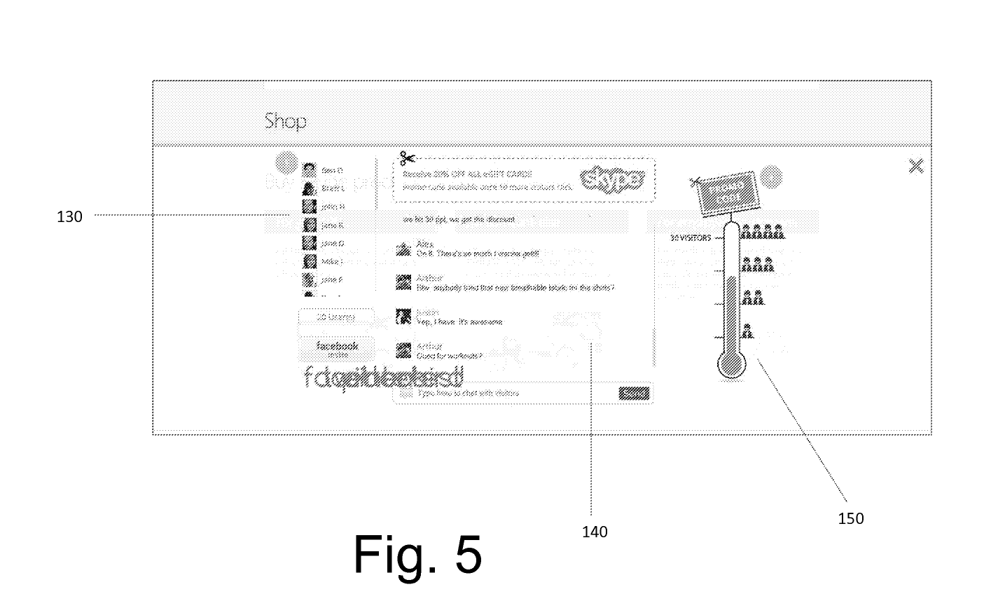

As shown in FIG. 5, after a potential consumer accepts the discount offer by clicking on the advertisement 110, the user is placed in a chat session 140 with other potential consumers who have accepted the discount offer presented in the advertisement. In the preferred embodiment of the system, the potential consumer may view the user profiles 130 of all other consumers who have accepted the discount offer. The system displays a chat session 140 where a potential consumer may type a message to other potential consumers who have accepted the discount offer. The potential customer may view a discussion history in the chat session 140 to see all statements made by other potential customers in the chat session 140. There may be a first count indicator 150 displayed by the system. The first count indicator 150 may be presented in any format that allows a potential consumer to see how many more potential consumers are required to accept the discount offer before the discount becomes activated. The system also utilizes a social connection interface which allows a potential consumer to invite social connections of the potential consumer to accept the discount offer as well. By inviting social connections into the chat session, the potential user becomes an active agent in influencing whether the threshold number of potential consumers is reached to activate the discount. For instance, a user may accept the discount offer and then simply click a button to invite facebook friends to view and accept the discount offer as well.

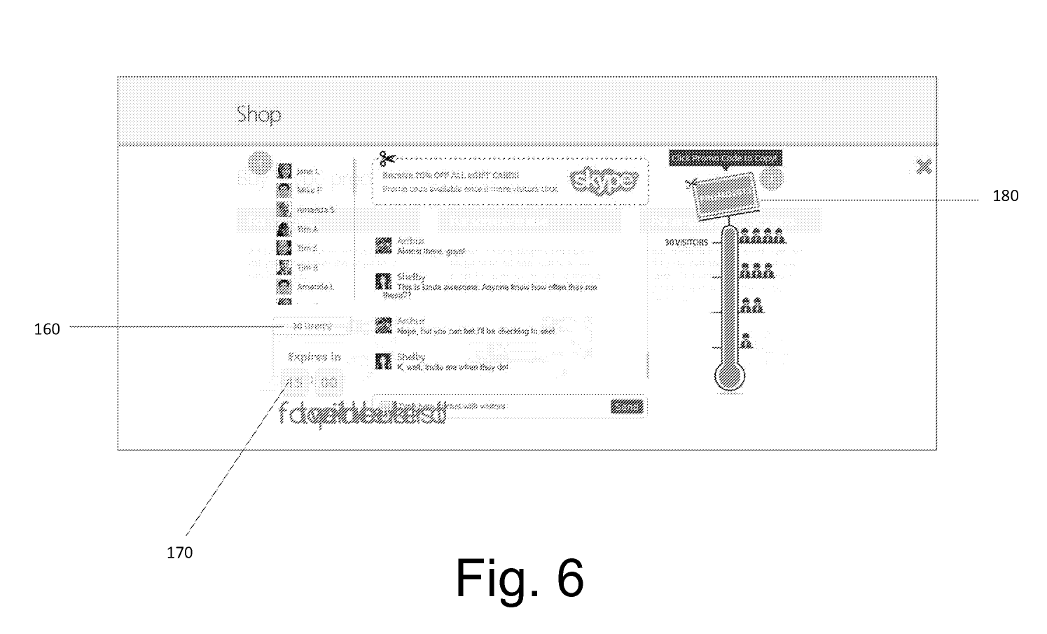

As shown in FIG. 6, the system may have a second count indicator 160. The second count indicator 160 may be displayed in any manner and may be identical to or different from the first count indicator 150. Any count indicator may display the current number of potential consumers who have accepted the discount offer or the current number of potential consumers required until the discount becomes activated.

FIG. 6 also displays the system after the threshold number of potential consumers has been attained. Once the threshold number of potential consumers has been attained, the system activates the discount and presents a redemption time indicator 170. The redemption time indicator 170 displays the amount of time the potential consumers have to redeem the activated discount. The system also presents a discount redemption button 180. A potential consumer redeems the activated discount by clicking on the discount redemption button 180. In other embodiments the discount may redeem automatically and the potential consumers are not required to take any action to redeem the activated discount.

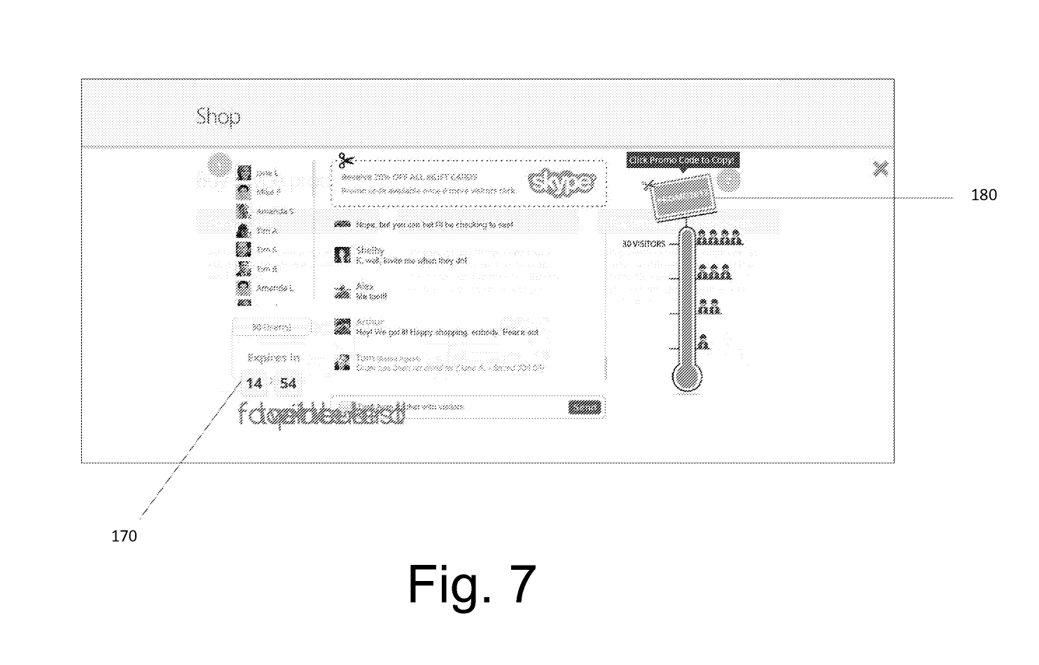

In the preferred embodiment, as shown by FIG. 7, the redemption time indicator 170 allows potential consumers fifteen minutes to redeem the activated discount. In this embodiment, potential consumers have only fifteen minutes to click on the discount redemption button 180, select items or services for purchase, and complete a transaction. The redemption time may be set by an administrator to be any amount of time. The redemption time indicator 170 displays the time as set by the administrator. The redemption time indicator 170 may count down and display the total time remaining for a potential consumer to redeem the activated discount. The potential time indicator may also be set to count up and display the time since the discount became activated.

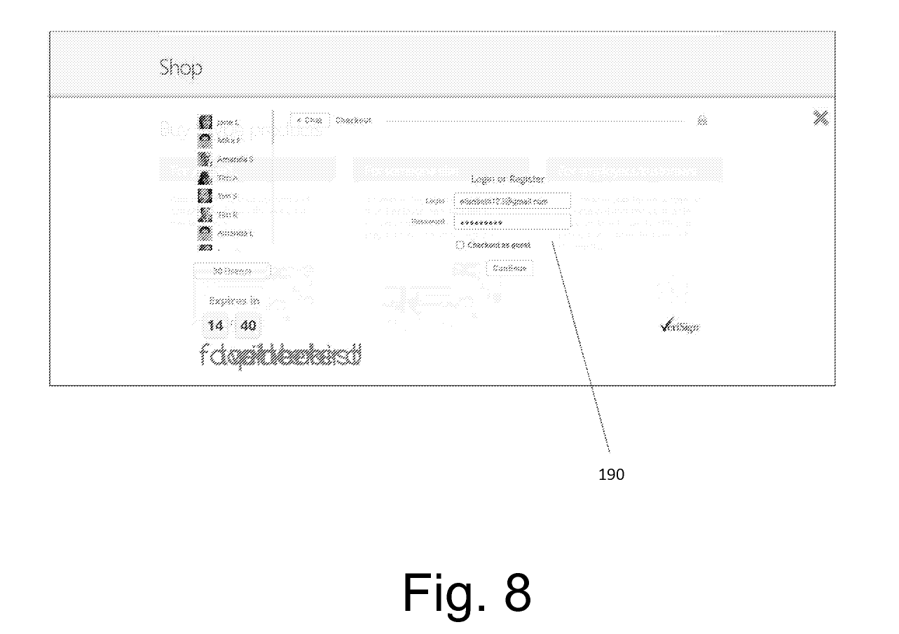

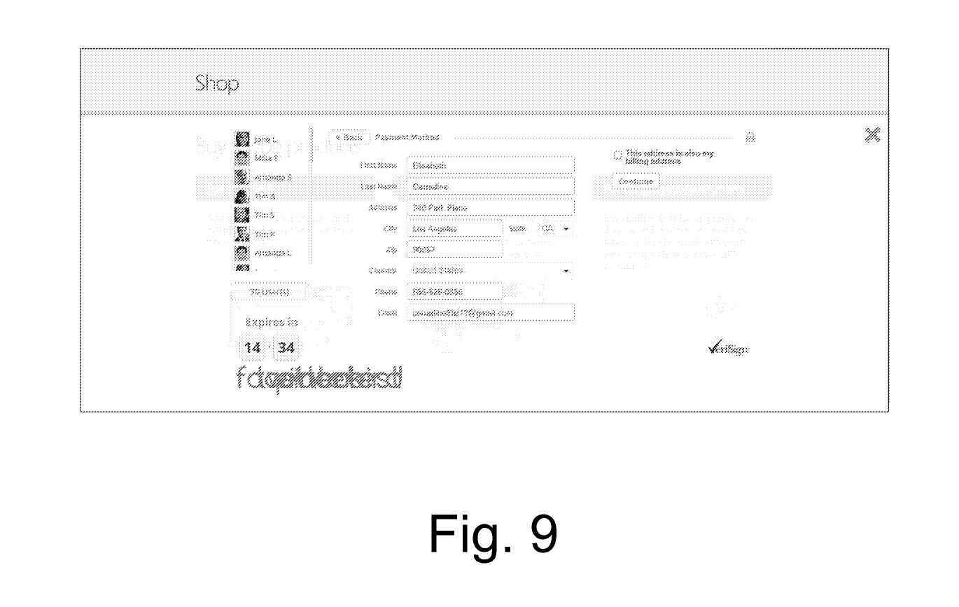

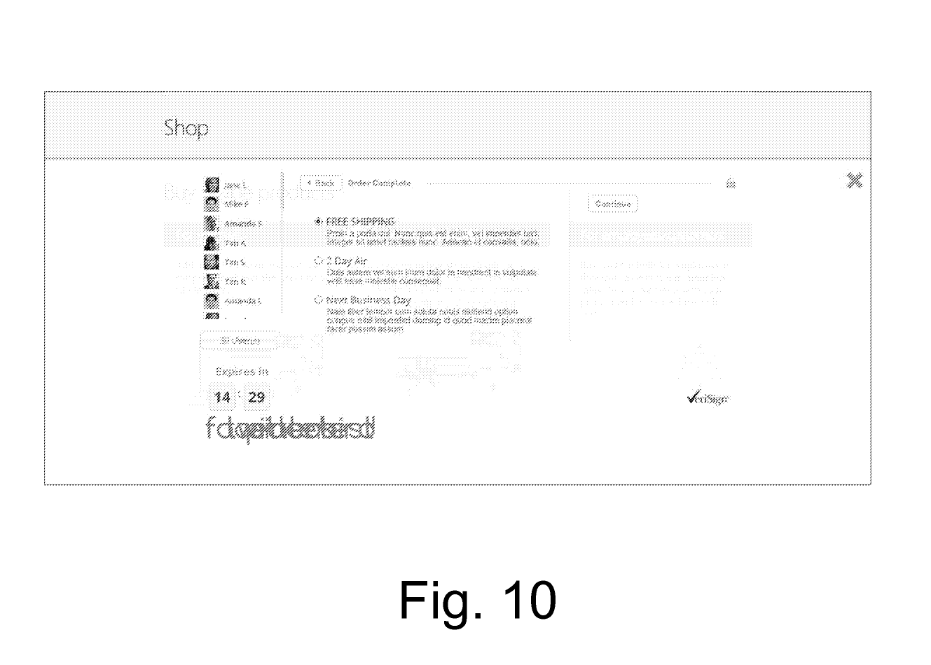

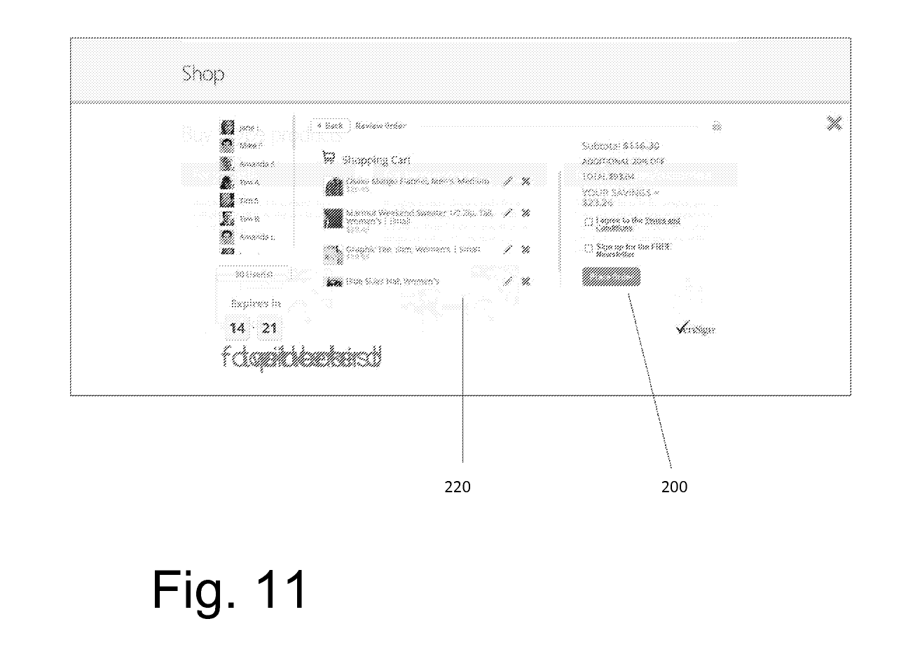

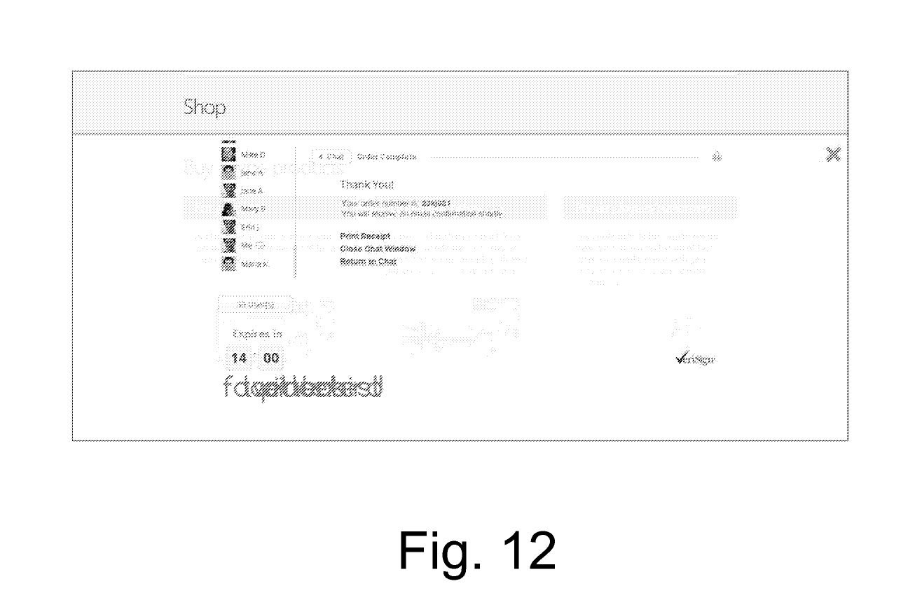

As displayed by FIG. 8, once the consumer has clicked on the discount redemption button 180, the user is directed toward a login screen 190. The login screen 190 requires a user to enter a user ID and password which the consumer had previously registered. Alternatively, if the consumer has not previously registered a user ID then the consumer may register a new user ID. Alternatively, in some embodiments, the consumer may purchase goods or services without logging in to a user ID. As displayed by FIG. 9, the consumer is then directed to a screen for entering payment information and shipping information. As displayed in FIG. 10, the consumer may select a shipping preference for shipping goods. As further displayed in FIG. 11, the consumer is then presented with a shopping cart 220. The shopping cart 220 displays the goods or services which the consumer is purchasing. In another embodiment, the system may allow the consumer to select goods or services or purchase after activating the discount. In another embodiment, the consumer may be required to select goods or services for purchase prior to activating the discount. In other embodiments, the discount offer may be for a specific good or service which is then automatically populated into the shopping cart 220. Once the consumer has confirmed all goods and services in the shopping cart 220 are correct and are desired to be purchased, the user can then select the order confirmation button 200. Selection of the order confirmation button 200 then finalizes the transaction. As shown in FIG. 12, the system then displays a transaction complete message and may present an order receipt or a confirmation number.

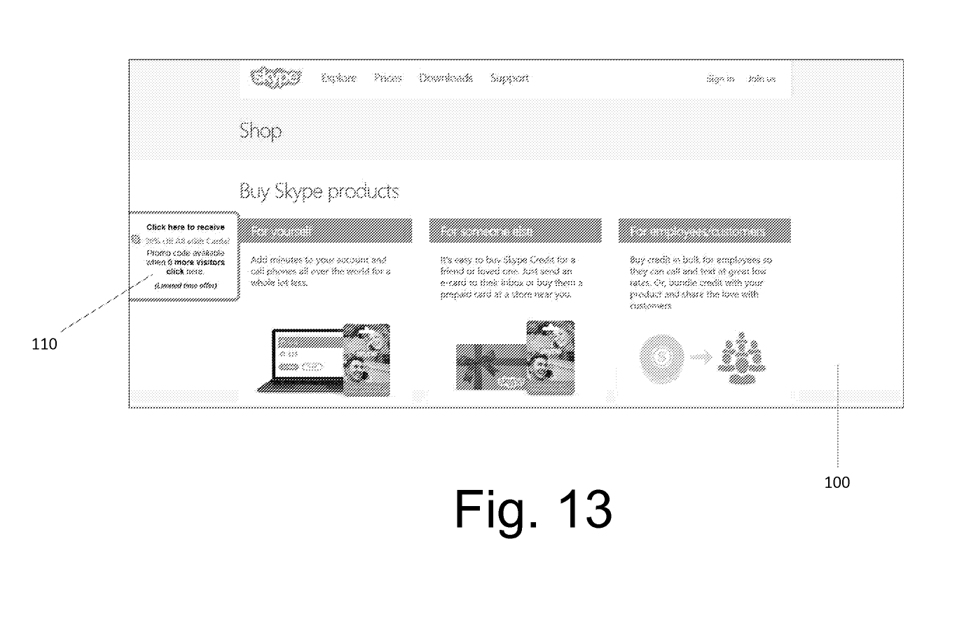

As shown by FIG. 13, once the threshold number of potential consumers has accepted the discount offer, the system may prevent other potential consumers from accepting the discount offer. In FIG. 13, a potential consumer who attempts to accept the discount offer may be presented with an advertisement 110 containing a message that no more discount offers are available or that zero more consumers are required to activate the discount. The system may also be set to remove the advertisement 110 once the threshold umber of consumers has been attained. Furthermore, the system may be set up to allow potential consumers to continue accepting the discount offer once the threshold number of consumers has been attained.

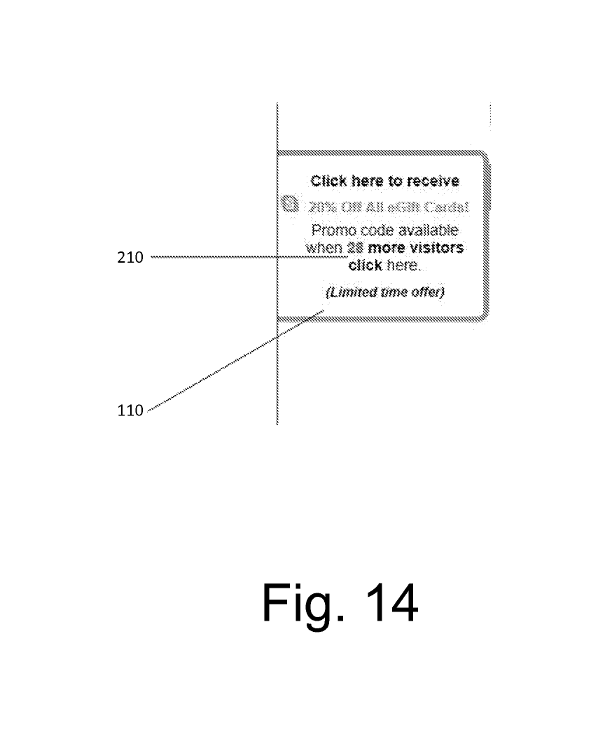

As displayed in FIG. 14, the preferred embodiment of the advertisement 110 is displayed. The advertisement 110 may be any size and shape, and may or may not utilize any font, any color, or any graphical image. The advertisement 110 may display a third count indicator 210. The third count indicator 210 may also constitute a display time indicator. As a display time indicator, the third count indicator 210 conveys for how long the advertisement will be displayed. The display time indicator may display the amount of time that the advertisement 110 will be displayed and during which the threshold number of potential consumers must be attained. Alternatively, as shown in FIG. 14, the display time indicator may be a third count indicator 210 which displays the number of potential consumers who must accept the discount offer for the threshold to be attained. In this embodiment, once the threshold number of potential consumers has been attained the advertisement 110 is no longer displayed on the specialized website 100.

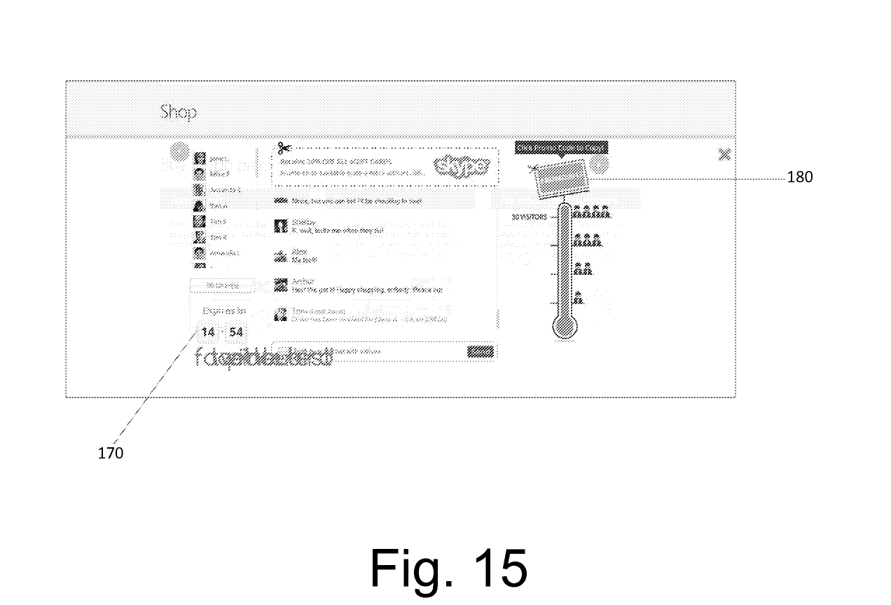

As displayed in FIG. 15, the system may present a discount redemption button 180. The discount redemption button 180 may automatically activate a discount when clicked on by a consumer. Alternatively, the system may present a discount code in place of the discount redemption button. The consumer may be required to write down the discount code for reentry into the system at the time of completing the transaction. Alternatively, the consumer may utilize a copy and paste function to reenter the discount code. Alternatively, clicking on the discount redemption button 180 may cause the system to automatically copy and reenter the discount code.

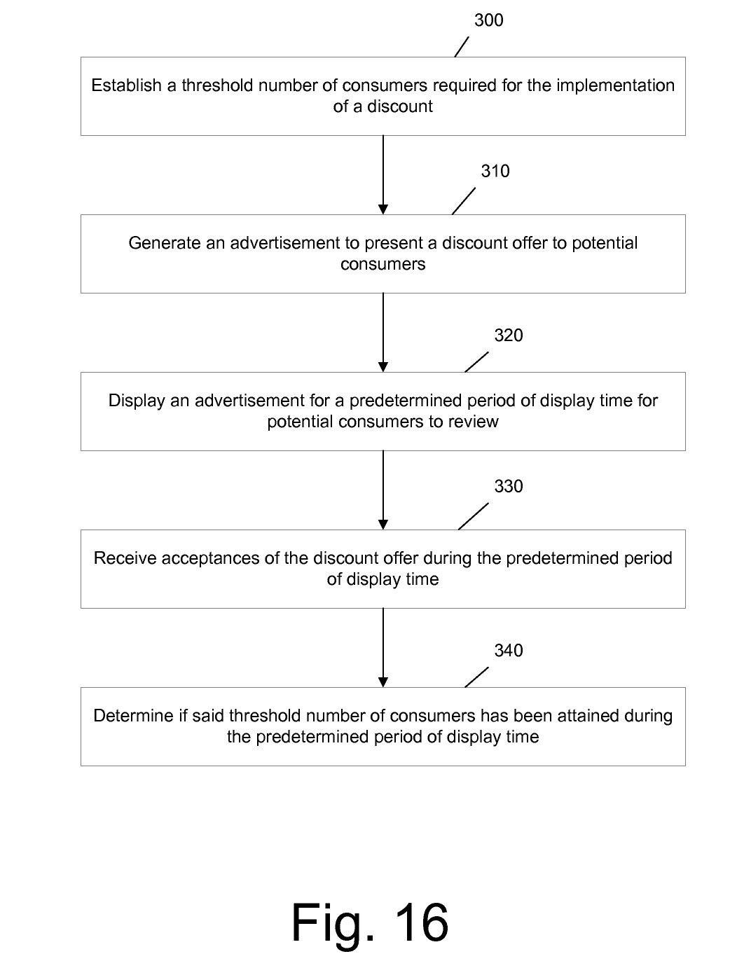

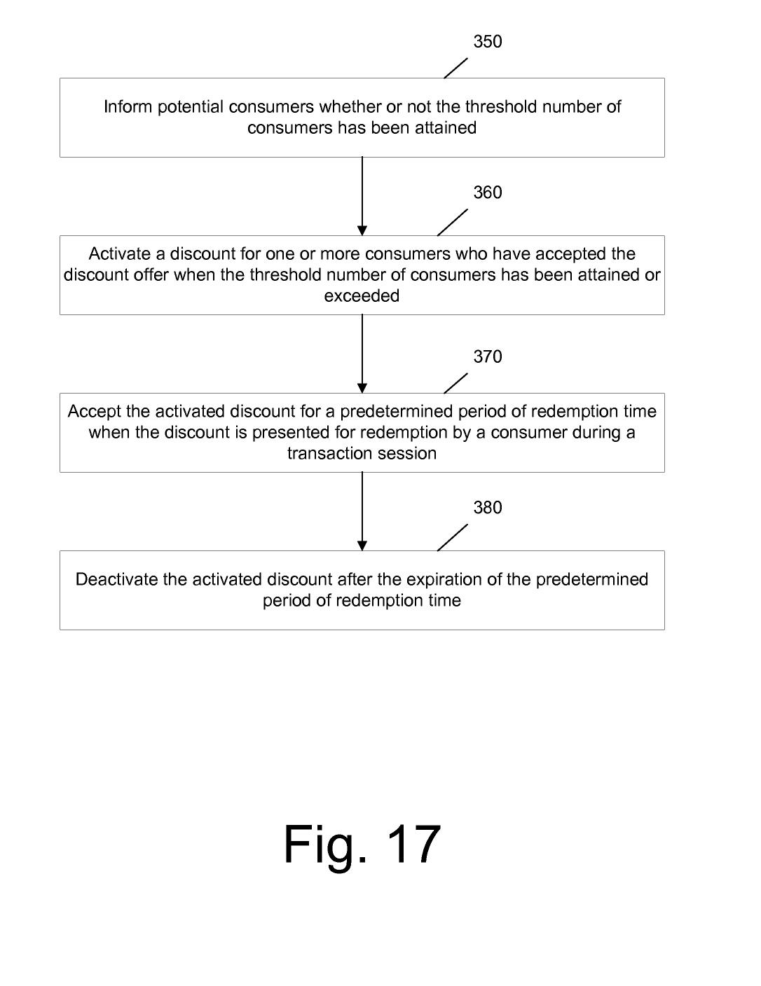

Referring to FIG. 16 and FIG. 17, the method of utilizing the invention is displayed. The process starts when an administrator establishes a threshold number of consumers required for the implementation of a discount 300. The system generates an advertisement to present a discount offer to potential consumers 310. The system displays an advertisement for a predetermined period of display time for potential consumers to review 320. The system receives acceptances of the discount offer during the predetermined period of display time 330. The system then determines whether the threshold number of consumers has been attained during the predetermined period of display time 340. The system then informs potential consumers whether or not the threshold number of consumers has been attained 350. The system then activates the discount for one or more consumers who have accepted the discount offer when the threshold number of consumers has been attained or exceeded 360. The system accepts the activated discount for a predetermined period of redemption time when the discount is presented for redemption by a consumer during a transaction session 370. The system then deactivates the activated discount after the expiration of the predetermined period of redemption time 380.

The invention may be utilized in many alternative embodiments, fashions, and forms. The individual components of the invention may be utilized as a collection or individually. The individual components of the invention include a novel chat system, a novel group discount system, and a novel hyper-conversion widget. Each component is described in further detail below.

Chat System

The invention provides for an online user chat system whereby a host provider can provide a user checkout system through an online chat popup widget. A host administrator will create a campaign for multiple client users to partake in a discount. The client user can invite multiple other client users to interact in the chat session. Within the popup widget session a purchase order system is provided. The purchase order system is dynamic such that the host agent can manipulate an item selected and purchase price of the item selected. The client user can purchase the selected item through the chat system popup window without navigating to a different window.

The chat system is established over a network. A chat system server computer that hosts chats, an ecommerce website server, and one or more visitor computer systems, one or more agent computers systems communicate over one or more networks, such as the Internet. The chat system server computer is equipped with a database or other means of storing and retrieving certain information. The chat system server computer allows visitors to textually converse with each other. The chat application displays the messages of each visitor with an indication of whom the message is from. The chat session may also be enabled with a voice session such that users may interact and communicate through both text and voice.

The chat system incorporates a payment system and shopping cart in the chat popup window. This incorporation is an improvement over the prior art in that a user is able to checkout and purchase items or services without navigating to an external page. During the chat session, an online shopping cart is displayed in an additional frame within the popup chat window. The shopping cart displays items selected by the client user along with a price per unit and the number of units selected for purchase. The shopping cart is dynamic. The number of items selected for purchase can be edited, added, or removed by the client user. The client user may also dynamically change the price per unit or the overall price of purchase by entering a coupon code.

The price per unit, the number of units, and the items selected for purchase can be edited, added, or removed by the host agent. The host agent can operate as a purchasing assistant for client user. The host agent may find items desired by the client user and add them directly to the shopping cart. In another embodiment, the host agent can search online for items or services for purchase and then direct the client user to the suggested item or service for purchase by putting a link in the text chat session. The client user can then select the hyperlink presented in the text chat session. The client will be redirected to the selected site and can choose the item or service for purchase directly. The frame displaying the item or service for purchase may appear in the chat session popup or may appear in a separate window from the chat session. When the client user selects the item or service for purchase the item is added to the shopping cart in the chat session popup. All changes to the shopping cart and checkout frame, made either by the client user or host agent, are effectuated in real time.

The shopping cart and checkout frame may be displayed in any one of a number of locations within the chat popup screen. The checkout frame may appear to the right of the chat session. In another embodiment, the checkout frame may appear to the left. In additional embodiments, the checkout frame may appear above or below the chat session.

The chat system allows for multiple host agents to and multiple client users to establish chat sessions simultaneously. One host agent may communicate with one client user via a chat session while a separate host agent communicates with a separate client user in a separate chat session at the same time. In another embodiment, one host agent may interact with multiple client users in one chat session. The chat system is established to allow the host agent and client users to interact with social media sites (i.e. facebook, LinkedIn, twitter, etc.) while engaged in the chat session. In one embodiment, a client user can specifically search for connections on facebook, determine which of those connections are currently online and active, and invite those connections to engage in the open chat session. The connections will receive an invitation with a link to the open chat session. Those connections who so desire can select to engage in the open chat session and will be added to the chat session. In one embodiment, the host administrator may establish a coupon or discount code to be used by a client user and the client user's social media connections who engage in the open chat session. Once a predetermined number of social media connections engage in the open chat session and utilize the widget, then the coupon or discount code will become effective. The client user and social media connections who have engaged in the open chat session may then click on the coupon and the discount is applied to the shopping cart within the widget. In another embodiment, one host agent can send an invitation to chat to multiple client users. The client users can then engage in a chat session with the host agent.

The host agent has the ability to interact with a multitude of other host agents. The interaction may be within the chat session or in a server side host program. This interaction will allow a host agent to establish a chat session with a client user and then notify a second host agent to enter the chat session. Once the second host agent enters the chat session the first host agent may leave the chat session or remain within the chat session.

The chat system server can retrieve information and data as needed from a database or an external e-commerce website. Information obtained from the database can include information about the client user that the host has obtained prior to a chat session, including, but not limited to, physical location, purchase history, social media IDs, and social media connections. Information obtained from the database may also include items or services selected by the client user for purchase. Information obtained from external e-commerce sites may include, but are not limited to, any information which may be scraped from the Internet, items or services available for purchase, items or services offered for sale by competitors of the host agent, or any other publicly available information. The chat system server also collects and stores information retrieved during an open chat session within the database. The information collected and stored during a chat session may include, but is not limited to, text messages transferred by a host agent or client user during the chat session, items which were selected for the shopping cart by either the client user or the host agent, any coupon or discount codes utilized during the chat session, the IDs of the client users and host agents invited to the chat session, the IDs of the client users and host agents engaging in the chat session, items or services purchased by any client user during the chat session, and any other relevant information.

In one embodiment of the invention, the client user may browse and search for items or services for sale during the chat session. The browsing frame may be incorporated into the chat session popup window or may be a separate window. The client user can search for items or services by keyword, by category, by seller, by product or service name, by price, or by any other relevant factor chosen from a plethora of elements. The searching and filtering of results may be established via textual input and search by the client user. The client user may also select radial buttons or other elements via dropdown boxes to filter through search results. The browsing frame will display the results of the search and filtering. The client user can then select an item or service for purchase. Upon selection, the item or service selected will populate into the shopping cart in the chat session.

In one embodiment of the invention, the host agent may create a group purchase incentive within the chat session. The host agent will give a special discount or special purchase price for an item for service for sale to client users who join into the chat session. The client users who join into the chat session commit to purchase the item or service upon engaging in the chat session. The host agent will set a group requirement for the sale of the item or the service such that the special discount or special price is effective only if a predetermined number of client users join the chat session and select to purchase the item or the service. Once the predetermined number of client users join the chat session and commit to purchase the item or service, the server system will finalize the sales process. Optionally, in one embodiment of the invention, the client users may be able to view the number of remaining coupons, remaining discounts, or remaining slots prior to engaging with the chat widget and joining the chat session.

In one embodiment of the invention, the administrator of a promotional campaign can allow users that are organically searching an e-commerce website to view the widget session and be proactively engaged to join for a discount. In this embodiment, the host administrator defines the specific parameters which must be met to allow client users to utilize a discount. Once set, the parameters are automatically implemented by the chat system server computer. Thus, the client users may interact within the system without the need for a host agent to moderate the widget or interact with the client users.

In another embodiment, the host agent can become a shopping assistant for the buyer with the intention to mirror a positive brick & mortar shopping experience. If a buyer has limited time in the widget, the agent can obtain his or her e-mail address, find particular items that may be suitable for the buyer, and follow-up outside of the widget via e-mail with choices the host may deem acceptable for the buyer.

The server system is organized such that the host agent may personalize the chat session established based on the client users messaged. In one embodiment, the host agent can upload information from the database to create a specific campaign or offer for a multitude of client users. The host agent may create a specific list of client users and offer a chat session for the sale of a specific item or service based on the client users' preferences. The host agent may predetermine a price or period of time for which an item or service is offered for sale to the client users. Optionally, in one embodiment of the invention, a time clock may be displayed showing the period of time remaining for any promotion or discount. Preferably the clock will count down the remaining time. The time clock may be viewed by client users prior to a client user engaging in any chat session. Optionally, the time clock may be viewed by client users within the widget after they have engaged with the chat session.

In another embodiment, the host agent may create an online auction. The host agent establishes a chat session with multiple client users. The host agent offers a specific item or service for sale within the chat session. The client users then enter offers for the purchase of the item or service. The client user who has offered the highest bid within the time frame determined will be determined to be the winning bidder. The sale of the item or service is then finalized to the client user with the winning bid.

Group Discount System

The invention further provides a group discount system which allows consumers to purchase and utilize a group discount from a merchant simultaneously and in real time. In one embodiment of the invention, a merchant may provide a group discount to a group of consumers for simultaneous purchase. The consumers may be registered users or nonregistered users of the merchant's website. The merchant begins by determining specific parameters for the group discount. The merchant may specify a predetermined number of users who must interact on the system to activate the group discount. Furthermore, the merchant may specify the type of discount available for the consumers. The merchant may provide any type of incentive to the consumers. This may include free shipping, a free gift, a monetary rebate, or a certain percentage discount. As an example, a merchant may provide a discount of 20% off of a purchase price which activates once twenty-five consumers interact through the chat system.

In the preferred embodiment of the invention, the merchant provides the group discount system as part of its standard ecommerce retail website. As users browse to the page, they are invited to engage in the daily deal promotion. The daily deal promotion provides a discount and specifies that it will only become active when the predetermined number of users engage with the system. A user who decides to partake in the daily deal will click the daily deal promotion. The user will then be entered into an online chatroom where the user can see all of the other users who are also presently in the chatroom. The users may converse with each other or with an agent of the merchant in the chatroom. Users may type in text messages in the chatroom which are viewable by all users who are present in the chatroom.

The user may register the user's identity in the merchant's chatroom in any manner. The user may sign in to the merchant's website using a unique user ID and password specific to the merchant's website. Optionally, the user may sign in using a social media user ID from a third party social media site, such as twitter or facebook.

When the user enters the chatroom, the user can view the remaining number of users required until the group discount is activated. As an example, the chatroom may display that five more users are required until the group discount activiates. The user may invite additional contacts to join the group chatroom, thus quickly reducing the additional number of users required and activating the group discount sooner. The user may invite additional users by emailing a link to the user's contacts. A contact may then click on the link and will be redirected to the chatroom session. Optionally, the user may post information about the group discount on a social media profile page of the user. Contacts who view the post on the social media page may click on a specific part of the post and be redirected to the chatroom session.

The group discount may be valid only for a specific amount of time. If the predetermined number of users required to activate the group discount do not join into the chat session in time, then the group discount does not activate. The chat session may cease at that point or the merchant may begin a new group discount for another specific amount of time. The user may be notified of the time remaining for a group discount by a time clock. For example, the chat session may display that only ten minutes remain for the required predetermined number of users to engage in the chat session for the group discount to activate.

When the predetermined number of users join the chat session, the group discount becomes activated. The group discount may be in the form of a specific text code provided to users. To redeem the group discount the users must type in the text code to a redemption box in the checkout cart located in the chat session. Optionally, the text code may autopopulate. Optionally, the group discount may be stored on the merchant's server. The group discount then becomes associated with the user ID of the user who engaged in the group discount chat session. The user may redeem the group discount simply by logging in to the user ID associated with that user.

In the preferred embodiment of the invention, the user may engage in the group discount chat session and then continue to shop online without disengaging from the chat session. As a user adds items to the user's cart, the cart in the chat session automatically updates with the purchase price and quantity of the item selected for purchase by the user. The user may minimize the chat session such that a single tab remains viewable while the user continues to shop and browse online.

In one embodiment, when the predetermined number of users join the chat session, the users are given a specific amount of time to redeem the group discount. The group discount may require all users who receive the group discount to purchase the items in the respective shopping carts at the same time. In this manner the users finalize their purchases substantially simultaneously.

In another embodiment, the users may be required to purchase the group discount. In such an embodiment, a user may be required to spend ten dollars prior to finalizing a purchase in order to gain twenty dollars worth of credit at the time of finalizing the purchase. Optionally, the users may not be required to purchase the group discount. In this embodiment, the users gain the use of the group discount merely for engaging in the group discount chat session. In this embodiment, the user does not pay any amount of money up front, or enter any payment information prior to finalizing the purchase. Instead the user only pays or enters payment information at the time of checkout. In this embodiment, a group discount may provide a specific percentage discount to the first fifty users who enter the chat session and finalize a purchase. In this embodiment, once required number of users enter the chat session the users may then checkout. At that time the percentage discount is applied.

In the preferred embodiment of the invention, all users finalize a purchase substantially simultaneously. In this embodiment, the users have shopped and chosen their respective items for purchase prior to entering into the chat session. A user may proceed to checkout directly, without engaging in the group discount. Otherwise, a user may engage in the group discount chat session for the purpose of receiving the group discount. Once in the group discount chat session, the items selected for purchase appear in the user's cart in the chat session. Once the predetermined number of users enter the chat session, the system then proceeds to finalize the purchases of the users. The users are then automatically redirected to checkout. In this manner the users all finalize their purchase substantially simultaneously.

Hyper-Conversion Widget

The invention is also directed toward a website visitor engagement tool for real-time, on-site conversations. The tool follows visitors on each page that a visitor visits, prompting the visitor to join a conversation regarding the material on the site. The visitor may engage in a conversation with other visitors who are also visiting the site or with agents of the site administrator. The tool will utilize a computer function to search and recognize keywords and phrases typed by the customer. The tool will compare the keywords and phrases with keywords and phrases from other known articles and webpages. The tool will then recommend other articles and websites to the visitor based on similar keywords and phrases. Thus the tool acts as a “smart” widget that recommends “relevant” content to visitors. The tool may also incorporate advertisements. If the keywords and phrases of the tool is not triggered by the words typed in by the visitor, then the tool will present advertisements to the user rather than list related content.

A user visits a website to read an article about an officer and a K9 killed during a manhunt. In the lower corner of the page is an overlay tab stating “join the conversation about this article.” Clicking on the tab brings the full conversation into view. The user can see the chat history, see their name, add a comment, and invite friends into the conversation about the article. When viewing the chat history, the user can reply to a specific text from a specific person or “like” a specific text from a specific user. The system may also allow the user to “dislike” or hide specific texts which the user does not like. The system will track the “likes” and/or “dislikes” to rank specific texts added to the conversation. The specific texts may be of any length. In the preferred embodiment the text displayed in the chat window is limited to a shorter specific number of characters. For specific texts longer than the limit, a user may click on “read more” to view the entire length of the specific text. The system will track and recognize keywords and phrases entered by the user or that the user tracks and likes in the texts of others. The system then presents a recommendation to the user to read another article. In the displayed example the system suggests that the user read “Another Food Stamp Deadline.” By clicking on the recommendation, a user is redirected to the webpage with that specific article and is presented with the chat window for that specific article.

The chat window may further display any new comments as they are entered into the conversation by other users. If the chat window is minimized the system presents the number of new comments since the user last had the chat window maximized—such as “2 new comments” or “3 new comments.” The software tools described herein may be incorporated with any website.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A computer implemented method of providing a group discount to a plurality of consumers comprising
a. On a server computer connected to one or more client computers through a network
i. said server computer comprising a microprocessor and a nonvolatile memory unit
ii. said nonvolatile memory unit storing instructions which when executed by said microprocessor cause the server computer to perform operations comprising
1. Establishing a threshold number of consumers required for the implementation of a discount
a. Wherein each of said consumers must be substantially simultaneously communicatively connected to said server computer through a respective client computer to be counted towards said threshold
2. Generating an advertisement to present a discount offer to potential consumers
3. Displaying said advertisement for a predetermined period of display time for potential consumers to review
4. Receiving acceptances of the discount offer during the predetermined period of display time
5. Determining whether all of said consumers who have accepted said discount offer are in substantially simultaneous communication with said server computer through respective client computers
6. Determining if said threshold number of consumers has been attained during the predetermined period of display time
7. Informing potential consumers whether or not the threshold number of consumers has been attained
8. Activating a discount for one or more consumers who have accepted the discount offer when said threshold number of consumers has been attained or exceeded
9. Accepting said activated discount for a predetermined period of redemption time when said discount is presented for redemption by a consumer during a transaction session
10. Deactivating said activated discount after the expiration of said predetermined period of redemption time

2. The method as in claim 1 further comprising
a. Displaying to potential consumers the user information of all potential consumers who have accepted said discount offer

3. The method as in claim 1 further comprising
a. Providing a chat room session on said server computer wherein potential consumers may post text messages

4. The method as in claim 1 further comprising
a. Providing a social network interface
i. Wherein said social network interface permits potential consumers who have accepted said discount offer to notify social connections about the discount offer and invite social connections to view said advertisement presenting said discount offer

5. The method as in claim 4 further comprising
a. Displaying to potential consumers the user information of all potential consumers who have accepted said discount offer

6. The method as in claim 5 further comprising
a. Providing a chat room session on said server computer wherein potential consumers may post text messages

7. The method as in claim 6
a. Wherein said advertisement presents a count indicator

8. The method as in claim 7
a. Wherein said count indicator indicates the number of potential consumers who have accepted said discount offer

9. The method as in claim 7
a. Wherein said count indicator indicates the number of potential consumers required to attain said threshold number of consumers

10. The method as in claim 7
a. Wherein said advertisement presents a display time indicator
i. Wherein said display time indicator presents the time remaining in said predetermined period of display time

11. The method as in claim 7 further comprising
a. Displaying a redemption time indicator
i. Wherein said redemption time indicator presents the time remaining in said predetermined period of redemption time

12. The method as in claim 11
a. Wherein said activated discount is effectuated by presenting a discount code to said plurality of consumers who have accepted said discount offer

13. The method as in claim 12
a. Wherein said activated discount is activated for no more than fifteen minutes after said threshold number of consumers has been attained

14. The method as in claim 13 further comprising
a. Requiring said potential consumers to log into a user profile prior to accepting said discount offer

15. The method as in claim 14 further comprising
a. Presenting services or merchandise for purchase by said potential consumers
b. Receiving notification of selection of services or merchandise for purchase by said one or more consumers
c. Storing said selected services or merchandise in a consumer specific shopping cart

16. The method as in claim 15 further comprising
a. Receiving a request to initiate a transaction session from one or more of consumers who have accepted the discount offer
b. Collecting transaction information during the transaction session from one or more consumers at respective clients in order to facilitate the purchase of selected services or merchandise
c. Processing transaction information collected during the respective transaction sessions

17. The method as in claim 7 further comprising
a. Requiring said potential consumers to log into a user profile prior to accepting said discount offer

18. The method as in claim 7 further comprising
a. Presenting services or merchandise for purchase by said potential consumers
b. Receiving notification of selection of services or merchandise for purchase by said one or more consumers
c. Storing said selected services or merchandise in a consumer specific shopping cart

19. The method as in claim 7 further comprising
a. Receiving a request to initiate a transaction session from one or more of consumers who have accepted the discount offer
b. Collecting transaction information during the transaction session from one or more consumers at respective clients in order to facilitate the purchase of selected services or merchandise
c. Processing transaction information collected during the respective transaction sessions

20. A system for providing a group discount to a plurality of consumers comprising
a. A server computer
b. One or more client computers communicatively connected to said server computer
c. A database communicatively connected to said server computer
d. A group discount module stored on said server computer
i. Said group discount module comprising executable computer code, which when executed by said server computer, performs a method comprising
1. Establishing a threshold number of consumers required for the implementation of a discount
a. Wherein each of said consumers must be substantially simultaneously communicatively connected to said server computer through a respective client computer to be counted towards said threshold
2. Generating an advertisement to present a discount offer to potential consumers
3. Displaying said advertisement for a predetermined period of display time for potential consumers to review
4. Receiving acceptances of the discount offer during the predetermined period of display time
5. Determining whether all of said consumers who have accepted said discount offer are in substantially simultaneous communication with said server computer through respective client computers
6. Determining if said threshold number of consumers has been attained during the predetermined period of display time
7. Informing potential consumers whether or not the threshold number of consumers has been attained
8. Activating a discount for one or more consumers who have accepted the discount offer when said threshold number of consumers has been attained or exceeded
9. Accepting said activated discount for a predetermined period of redemption time when said discount is presented for redemption by a consumer during a transaction session
10. Deactivating said activated discount after the expiration of said predetermined period of redemption time

21. The system as in claim 20 wherein said method further comprises
a. Receiving a request to initiate a transaction session from one or more of consumers who have accepted the discount offer
b. Collecting transaction information during the transaction session from one or more consumers at respective clients in order to facilitate the purchase of selected services or merchandise
c. Processing transaction information collected during the respective transaction sessions

22. The system as in claim 20 wherein said method further comprises
a. Displaying to potential consumers the user information of all potential consumers who have accepted said discount offer

23. The system as in claim 20 wherein said method further comprises
a. Providing a chat room session on said server computer wherein potential consumers may post text messages

24. The system as in claim 20 wherein said method further comprises
a. Providing a social network interface
i. Wherein said social network interface permits potential consumers who have accepted said discount offer to notify social connections about the discount offer and invite social connections to view said advertisement presenting said discount offer

25. The system as in claim 24 wherein said method further comprises
a. Displaying to potential consumers the user information of all potential consumers who have accepted said discount offer

26. The system as in claim 25 wherein said method further comprises
a. Providing a chat room session on said server computer wherein potential consumers may post text messages

27. The system as in claim 24
a. Wherein said advertisement presents a count indicator

28. The system as in claim 27 wherein said method further comprises
a. Displaying a redemption time indicator
i. Wherein said redemption time indicator presents the time remaining in said predetermined period of redemption time

29. The system as in claim 28
a. Wherein said activated discount is effectuated by presenting a discount code to said plurality of consumers who have accepted said discount offer

30. The system as in claim 29 wherein said method further comprises
a. Receiving a request to initiate a transaction session from one or more of consumers who have accepted the discount offer
b. Collecting transaction information during the transaction session from one or more consumers at respective clients in order to facilitate the purchase of selected services or merchandise
c. Processing transaction information collected during the respective transaction sessions
